(19) United States
(12) Patent Application Publication
(10) Pub. No.: US 2008/0022231 A1
(43) Pub. Date: Jan. 24, 2008

(54) Systems and Methods for Downloading Interactive Content to Implement Remote Control Functionality in a Video Playback Device

(75) Inventors: Yi-Chao Tsai, Taipei City (TW); Fu-Kai Juang, Taipei City (TW)

Correspondence Address: THOMAS, KAYDEN, HORSTEMEYER & RISLEY, LLP, 600 GALLERIA PARKWAY, STE 1500, ATLANTA, GA, 30339, US

(73) Assignee: CYBERLINK CORP., Shindian City (TW)

(21) Appl. No.: 11/619,703

(22) Filed: Jan. 4, 2007

Related U.S. Application Data
(60) Provisional application No. 60/807,941, filed on Jul. 21, 2006.

(51) Int. Cl. G06F 3/00

(52) U.S. Cl. 715/840; 715/719

(57) ABSTRACT

Embodiments of the present disclosure provide a system and method for downloading interactive content, which provides remote control functionality in a video playback system. Briefly described, one embodiment, among others, is directed to a method for selecting buttons in pages within a video. The method comprises selecting a video, downloading interactive content associated with the video from a server, wherein the interactive content identifies all selectable buttons in each page within the video and contains the properties for each button. Finally, the method comprises utilizing the interactive content to interact with the video.

### CROSS-REFERENCE TO RELATED APPLICATION

This application claims priority to, and the benefit of, U.S. Provisional Patent Application ______ entitled, “SYSTEM AND METHOD FOR IMPLEMENTING REMOTE CONTROL FUNCTIONS IN A MOUSE IN A VIDEO PLAYBACK SYSTEM,” having Ser. No. 60/807,941, filed on Jul. 21, 2006, which is incorporated by reference in its entirety.

### TECHNICAL FIELD

The present disclosure generally relates to downloading interactive content, which provides remote control functionality for a video playback device.

### BACKGROUND

Video playback systems are well known, and there are a variety of current standards that govern the format and other attributes associated with the various video playback systems. Today, the DVD (Digital Video Disc) standard is the predominant format utilized for optical disc storage because of its high storage capacity, thus enabling high quality video and audio to be stored. Consequently, media content such as movies, television shows, and music videos are made widely available in DVD format. One of the appealing aspects of DVDs over other storage formats such as VHS tapes (Video Home System) is the interactive menu(s) offered on DVDs in addition to the movie itself. These interactive menus have become an integral part in fully enjoying media content, such as a movie or television show on a DVD. For example, now, in addition to watching a movie, consumers can select specific chapters to view, set audio/video options (language for the movie to be played in, subtitles, etc.), and even watch additional footage such as a “behind-the-scenes” look in making the movie. Some DVDs even offer “alternate endings” where consumers can actually select an ending of their choice should they not like the original ending. Since DVD players first became available to consumers in the mid to late 1990's, DVD players are common in many households. This is due in part to the drop in cost of DVD players, therefore making them affordable to consumers. Furthermore, today most personal desktop and laptop computers are sold with a DVD-ROM player built in, making DVD players even more widespread and even more portable than before.

Typically, with a conventional stand-alone DVD player (e.g., a player not integrated into a computer system and one that requires a separate display device such as a television), the DVD player will come with a remote control which the consumer uses to access features offered by a DVD. With this remote control, the consumer is able to navigate through the hierarchy of interactive menus a particular DVD might offer. A typical remote control for a DVD player will include a set of up/down and left/right arrows. Some remote controls might include a SELECT button in the middle of an arrangement of up/down, left/right navigational buttons. The navigational buttons allows users to intuitively move more around within a menu. For example, in a screen allowing the user to select a specific chapter to view, a series of thumbnail screen shots might be shown on the screen in a grid arrangement (e.g., in a 2×2 arrangement). A particular thumbnail, say the upper left thumbnail on the screen, might be selected by default and highlighted. From there, the user would simply use the up/down, left/right navigational buttons to highlight a different thumbnail until the desired thumbnail is highlighted. The user might then press the SELECT button to enter his selection. Based on this, the corresponding chapter in the movie will be played.

With DVD players integrated into desktop computers or laptops, the user will generally rely on a graphical user interface (GUI) instead of a remote control to navigate through the series of menus within a DVD. The GUI will generally emulate the same functionality as a remote control. For example, the user can still select chapters to view, fast forward, reverse, set audio/video options, etc. However, instead of navigating through a menu using a series of up/down, left/right selections, the user might click a button shown on the screen using an input device such as a mouse or touch pad on a laptop.

Today, there are various standards in consideration to become the successor to the DVD standard. Two formats competing to become the next generation optical standard are BLU-RAY DISC® and HD DVD® (High Definition Digital Video Disc). As with these newer standards, BLU-RAY DISC® offers advantages over DVDs and other previous optical standards in various ways including increased storage capacity and enhanced interactivity (disc content authoring, seamless menu navigation, network/Internet connectivity, etc.). The BLU-RAY DISC® framework offers content providers almost unlimited functionality when creating interactive titles. The author has complete freedom in designing the user interface, which is controllable by using standard navigational buttons on a remote control.

With DVDs, playback is interrupted each time a new menu screen is called. For example, if a user desires to change the language from English to French while watching the movie, the user has to select the audio menu. This, however, causes the movie to stop playing, and a menu is displayed for the user to select from. Upon making his selection, the user then returns back to viewing the movie. Due to BLU-RAY DISC's® ability to read data from the disc without interrupting the current audio/video stream, various menus can be displayed while the movie is playing. Furthermore, the menus may consist of several pages. Users will be able to browse through various pages of menu selections without interrupting the movie.

Also with DVDs, user browsable slideshows were not possible with uninterrupted audio. As a result of BLU-RAY DISC's® ability to read data from the disc without interrupting the current audio/video stream, users can browse through various still pictures (e.g., snapshots of various scenes in the movie) while the audio remains playing. This applies not only to forward and backward selections: A user can make different selections on what picture to view (or select from a screen presented with thumbnail images) while the audio remains playing. With DVDs, subtitles were stored in the audio/video stream, and therefore they had limitations on the number of languages and display styles. Again, it is due to BLU-RAY DISC's® ability to read data from the disc without interrupting the current audio/video stream, that subtitles can be stored independently on the disc. A user may select different font styles, sizes and colors for the subtitles, or location on screen, depending on the disc's offerings. Subtitles can be animated, scrolled or faded in and out.

As with the BLU-RAY DISC® standard, new features have also been added to the new HD DVD® standard which provide for enhanced interactive features over DVDs. The HD DVD® framework also allows interactive content to be authored for discs.

Regardless of the particular standard, newer-generation video standards such as BLU-RAY DISC® and HD DVD® are providing greater levels of user control and interactivity with the underlying video content. One area embodying such interactivity relates to the presentation and utilization of buttons. As is known, in interactive graphics, a menu contains one or more pages. Similarly, a page contains one or more buttons, and a button is defined by coordinates (e.g., x-y coordinates), a graphical object, and one or more associated commands. For example, in the context of a DVD video, a user is typically provided with various functions, such as a scene-selection function. In this function, a user may be presented with a variety of single image graphics, which are taken from, and associated with, each of a plurality of scenes. By using the remote control for the DVD player, the user may highlight, or select, any of these images, and may further instruct the DVD player to proceed directly to a given scene by activating the corresponding highlighted image.

From a more technical standpoint, these images, as seen by the user, are provided in the form of mechanisms called “buttons.” As mentioned above, each such button is defined by coordinates (e.g., the x and y location where the button will be presented on the screen), a graphic object (i.e., the image that is presented to the user), and one or more associated commands (e.g., a command that directs the DVD player to jump or skip directly to a selected scene).

Reference is now made to FIG. 1, which depicts an exemplary multi-page menu within a video playback system, such as a DVD player. A user typically navigates through the various pages using a remote control. When a user inserts a video disc (e.g., a DVD video), a main menu may be presented on a first page 102 to a user displaying “Main Menu” 104, “Languages” 106, and “Chapters” 108. Using the arrow keys on a remote control for the DVD player, the user may highlight the button for the “Languages” menu 106 option. Once highlighted, the user may press the SELECT key on the remote control, which causes a second page 110 to be presented to the user, having a heading of “Languages” 112. Underneath this heading, a series of buttons may be presented for each language of the associated audio. The languages illustrated in FIG. 1 are “English” 114 and “French” 116.

Alternatively, and as indicated in FIG. 1, if the user highlighted and activated the “Chapters” button 108 from the first page 102, then the third page 118 is presented to the user. As illustrated, this third page includes a heading of “Chapter 1” 120 along with four additional buttons labeled as “Scene 1” 122, “Scene 2” 124, “Main” 126, and “Next” 128. Again, the user may navigate these buttons using the arrow keys on the remote control to highlight any of these buttons. Once highlighted, the user may press a SELECT key provided on the remote control to activate the given button. For example, and as illustrated in the figure, if the user were to activate the “Next” button 128, then the menu would proceed to display a fourth page 132 (presenting image buttons for “Scene 3” 134 and “Scene 4” 136 to the user). As is known, new video standards provide for these and other robust interactive features, which have generally enhanced the user's experience with the graphics medium.

Notwithstanding these enhanced features, however, certain problems have been found to arise. One example where such problems have been found to arise is in the use of computers (rather than designated video players) to display or view the videos. Specifically, a problem arises when using standard input/output devices of a computer, such as a mouse, to interact with the video content, instead of using the remote control that is provided with a dedicated video player (e.g., DVD player). When the same video disc is being executed or displayed on a computer, it has been found that a user may freely select otherwise non-selectable buttons, simply by moving the mouse over the top of the button. Returning to the example presented above, if the user were to move the mouse across the “Languages” button 112 on the second page 110, this would result in an unintended operation. Depending on how the underlying computer program handled it, various different and unintended results could occur. For example, the button may be presented in a highlighted fashion to the user. However, when the user left-clicks the mouse to activate the button, the video program may do nothing as the video disc does not intend that button to be one that can be selected or activated from that page. As an example, in the second page 110, the “Languages” button 112 is not intended to be selectable as denoted by the dotted lines. Only the two buttons below this button (“English” 114 and “French” 116) are meant to be selectable. Attempting to activate the “Languages” 112 button in this case could cause the computer program to crash, depending on how the underlying application processes the selection request.

For purposes of providing nomenclature herein, a button, typically, has one of four possible states. Reference is now made to FIG. 2, which depicts the different states for buttons within a video playback system. These states include a “disabled” state 202, a “normal” state 204, a “selected” state 206, and an “activated” state 208. Referring back to FIG. 1, for the second page 110 being displayed, the “Languages” 112 button would be in a disabled state, as the underlying video content software does not intend for that button to be selected from that particular page. (This is denoted by the dotted line around the button.) The “French” button 114 is in the normal state, while the “English” button 114 is in the selected state. When the user clicks the left mouse key, when the mouse pointer is overlying a selected button, or when the user presses the SELECT key of a remote control for a selected button, then that selected button becomes activated and therefore enters the activated state 208. The activated state 208 is a temporary state, which typically leaves the underlying video content or software to execute the one or more commands that are associated with the button.

As illustrated in FIG. 2, from the activated state 208, a button may proceed to any of the other three possible states. Again in FIG. 1, for the first page the “Languages” button 106 is selected. Upon activation of the “Languages” button 106, the associated command causes, among other possible operations, the menu to proceed to the second page 110. At this time, the “Languages” button 112 enters the disabled state, as it is not intended for selection from this page of the menu. To provide a specific illustration, and returning to FIG. 1, in the last three pages (of the four pages presented in the figure), the top-most button may be a non-selectable button. That is, in the second page 110, the figure illustrates three buttons of “Languages” 112, “English” 114, and “French” 116. The system, however, may be designed to only permit the user to select the buttons of “English” 114 and “French” 116. In this regard, the “Languages” button may be a non-selectable button. Thus, when the “English” 114 is highlighted, and the user depresses the up arrow key on the remote control the “Languages” will not be highlighted or selected when a user interacts with the video disc using the remote control of the dedicated video disc player.

Such features may be implemented, in part, through certain properties of buttons, such as a “neighbor” property. As is known, and defined by certain video specifications (e.g., Blue-ray Disc® specification) a button may be defined to have neighbors to the left and right or top and bottom. In such a situation, when a given button is selected (e.g., highlighted) pressing any of the up-arrow, down-arrow, left-arrow, or right-arrow button on the remote control operates to select, or highlight, the button that is defined to the be neighbor of the selected button in the direction selected by the remote control. However, it is not required that neighbors be so associated with buttons in any given direction (or even at all). Therefore, in returning to the figure, it may be that only the “French” button 116 is associated with the “English” button 114 as a neighbor. Therefore, when the “English” button 114 is selected, only the down-arrow key will be recognized as a valid or legitimate arrow-key input (e.g., other arrow keys are ignored). This way, the user is not permitted to select, with the remote control, any button presented on the screen that is not intended for selection in the current page or context of the video presentation.

However, when the same video disc is being executed or displayed on a computer, it has been found that a user may freely select otherwise non-selectable buttons, simply by moving the mouse over the top of the button. Returning to the example presented above, if the user were to move the mouse across the “Languages” button 112, this would result in an unintended operation. Depending on how the underlying computer program handled it, various different and unintended results could occur. For example, the button may be presented in a highlighted fashion to the user. However, when the user left-clicks the mouse to activate the button, the video program may do nothing (as the video disc does not intend that button to be one that can be selected or activated from that page). Alternatively, attempting to active such a button could cause the computer program to crash.

An example of another issue when attempting to use a mouse or other computer input device arises when two buttons are overlaid with each other. When playing a video disc using a computer and while interfacing with the interactive video disc using an input device such as a mouse, problems may arise. As noted above, one problem may be that the system generates errors or confusing results when the mouse is moved over any of buttons in a normal state, but not intended for selection. In addition, when using the mouse to select the overlaid buttons, the user does not have a ready means for toggling between those two buttons, since they are displayed in identical locations on the screen. In this regard, pressing the mouse key will select whichever of those buttons is currently highlighted, but will not permit the user to toggle to the other button, since the mouse does not have a key corresponding the left-arrow or right-arrow keys of the remote control.

Yet another issue or problem arises in connection with the use of “transparent” buttons or buttons that are too small in size. Transparent buttons are sometimes used as a convenient tool to provide an action when a user depresses a certain button on the remote control input device, without visibly presenting the button to the user. Because these buttons may not be visible to the user, it is not feasible for a user to use a mouse to select these buttons because the precise location is not known.

The foregoing presents just a few examples of situations in which interactive video graphics are provided which require handling beyond the conventional “point-and-click” action of a mouse. Accordingly, solutions to these and other similar problems are desired.

### SUMMARY

Embodiments of the present disclosure provide a system and method for downloading interactive content, which provides remote control functionality in a video playback system. Briefly described, one embodiment, among others, is directed to a method for selecting buttons in pages within a video. The method comprises selecting a video, downloading interactive content associated with the video from a server, wherein the interactive content identifies all selectable buttons in each page within the video and contains the properties for each button. Finally, the method comprises utilizing the interactive content to interact with the video.

Another embodiment includes a system for selecting buttons in pages within a video. The system includes a database for storing interactive content associated with a first video and a video playback device containing a second video, wherein the video playback device is configured to download the interactive content, which allows a user to interact with the second video.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE DRAWINGS

Many aspects of a system for remotely implementing remote control functions through a mouse in a video playback system and the underlying methods can be better understood with reference to the following drawings. The components in the drawings are not necessarily to scale, emphasis instead being placed upon clearly illustrating the principles of remote video editing system. Moreover, in the drawings, like reference numerals designate corresponding parts throughout the several views.

FIG. 1 depicts an exemplary multi-page menu within a video playback system.

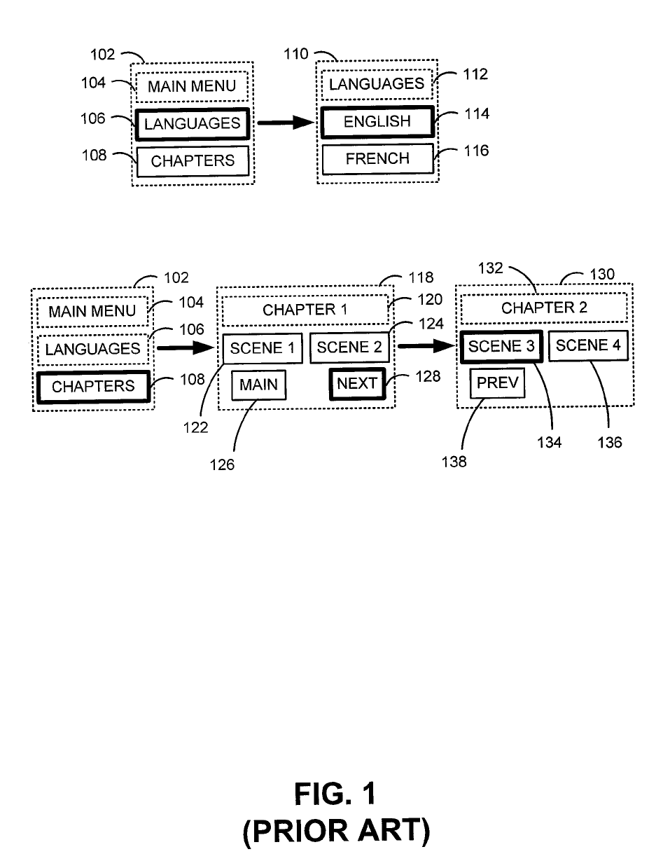

FIG. 2 depicts the different states for buttons within a video playback system.

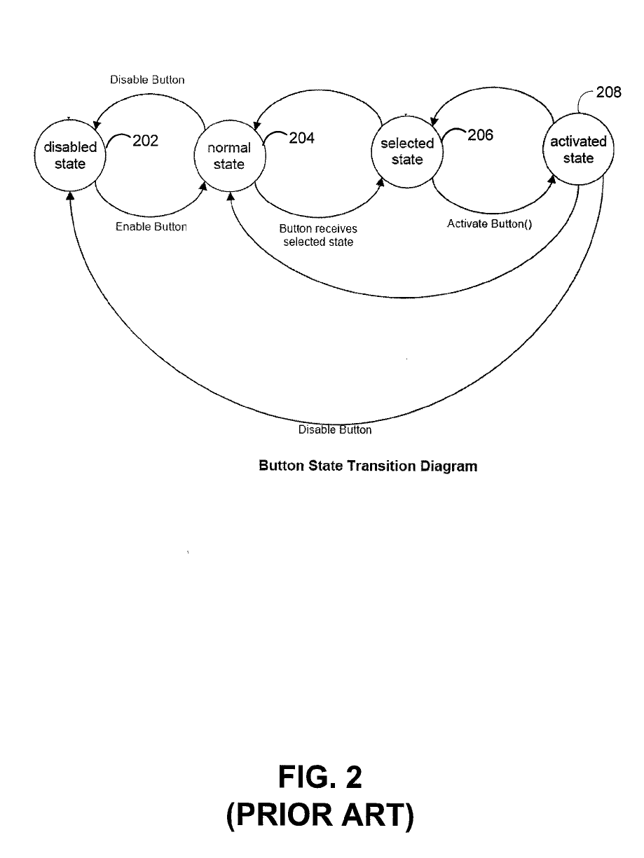

FIG. 3 is a flow diagram that illustrates an embodiment of a method for downloading interactive content, which provides remote control functionality in a video playback system.

FIG. 4 is a block diagram illustrating an embodiment of a system for downloading interactive content, which provides remote control functionality in a video playback system.

FIG. 5 is a block diagram further illustrating an embodiment of a system for downloading interactive content, which provides remote control functionality in a video playback system.

FIG. 6 illustrates remote control functionality that may be provided by interactive content.

FIG. 7 illustrates remote control functionality that may be provided by interactive content.

FIG. 8 is a block diagram illustrating an exemplary embodiment of a system for downloading interactive content.

### DETAILED DESCRIPTION

Having summarized various aspects of the present disclosure, reference will now be made in detail to the description of the disclosure as illustrated in the drawings. While the disclosure will be described in connection with these drawings, there is no intent to limit it to the embodiment or embodiments disclosed herein. On the contrary, the intent is to cover all alternatives, modifications and equivalents included within the spirit and scope of the disclosure as defined by the appended claims.

Embodiments of systems and methods for downloading interactive content to provide remote control functionality in a video playback system are described. Interactive content generally refers to newly created video content integrated into an existing video which emulates the functionality of a remote control through the use of a standard input/output device in a video playback system. For example, interactive content may be created which provides a means to select buttons that are transparent or too small for the user to see. This interactive content is particularly useful when conventional “point-and-click” operations of a mouse are not sufficient to navigate through multi-page menus offered by a particular video. In some embodiments, buttons that require special selection methods beyond conventional means of selecting buttons are detected and identified. This information is stored as interactive content on a server for future access so that a third party may later download this interactive content. This interactive content provides the third party with instant remote control functionality for selecting buttons through the use of a standard input/output device, such as a mouse.

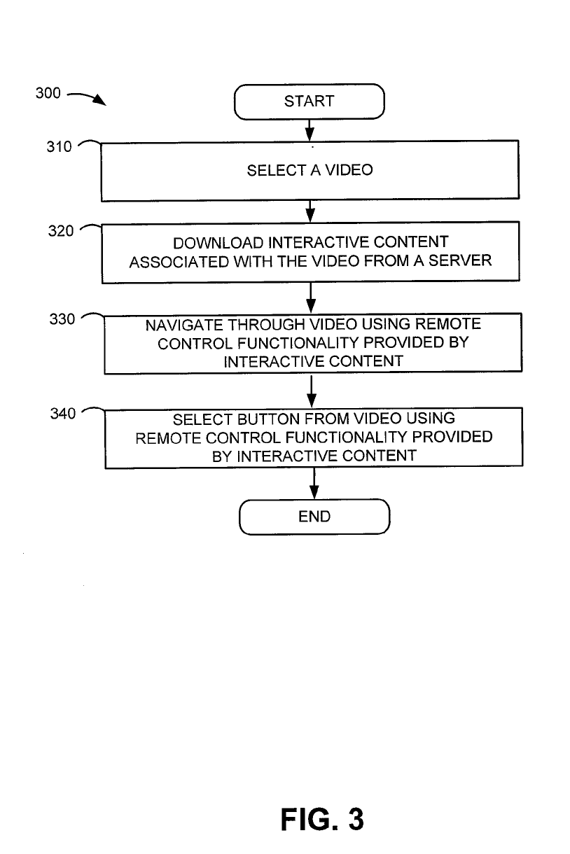

FIG. 3 is a flow diagram that illustrates an embodiment of a method for downloading interactive content, which provides remote control functionality in a video playback system. Beginning with step 310, a video is selected for viewing. The video selected determines which interactive content is downloaded from the server in the event that the server contains interactive content for multiple videos. The video selected may contain a plurality of pages with buttons stored within each page. However, some of these buttons may require special handling because the buttons are transparent or too small, for example. To select these buttons, interactive content associated with the video is downloaded from a server (step 320). This interactive content is used to interact with the video. A user navigates through pages within the video (step 330) and selects a button using the interactive content (step 340). As an example, the interactive content may provide a series of graphical arrows, which a user uses to navigate between buttons before making a selection.

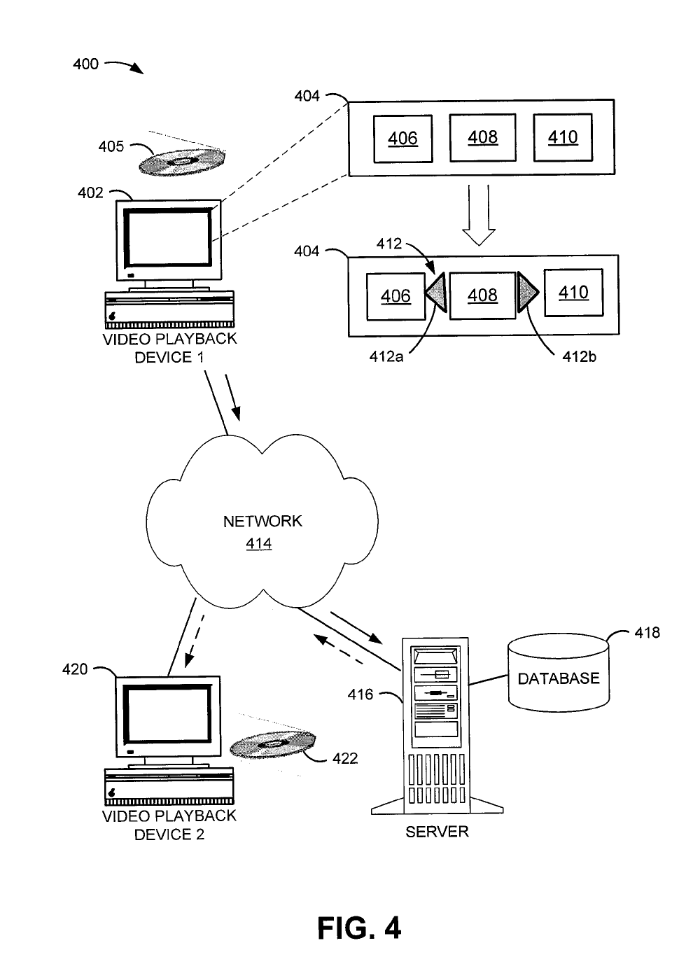

Reference is now made to FIG. 4, which provides a block diagram illustrating an embodiment of a system for downloading interactive content, which provides remote control functionality in a video playback system. The system in FIG. 4 comprises various video playback devices 402, 420 and a server 416. In some embodiments, the video playback devices 402, 420 may be, but are not limited to, any type of computing device such as a desktop computer or a laptop computer. In some embodiments, the video playback devices 402, 420 may be Blu-ray Disk® players or HD DVD® players. In general, video playback devices 402, 420 provide users with a means for viewing and interacting with videos.

Shown in FIG. 4 is an example of a page 404 presented within a video 405. The page 404 contains a plurality of buttons 406, 408, 410 which a user selects from to interact with other multi-page menus offered by the video 405. A button is defined by coordinates (e.g., x-y coordinates), a graphical object, and one or more associated commands (e.g., a command that directs a video playback device to jump or skip directly to a selected scene). As illustrated in FIG. 4, the first video playback device 402 processes the video 405 to generate new interactive content, which provides remote control functionality through the use of a standard input/output device, such as a mouse. In this example, the newly created interactive content takes the form of graphical interface 412, which allows a user to navigate to other buttons. In this case, the graphical interface 412 is comprised of navigation arrows 412a, 412b which the user may utilize to select neighboring buttons 406, 410 using a standard input/output device such as a mouse. One should note that for some embodiments, interactive content might be generated in other ways other than through video playback devices. For example, a designer of user interfaces might create interactive content for a particular video using a computing device loaded with graphical software. Such computing devices may include, but are not limited to, desktop computers, portable computers, and dedicated server computers. A separate user may then download this interactive content to interact with the video.

The video playback devices 402, 420 may be connected through a network 414, which may, for example, be a LAN, WAN, or the Internet. The server 416 may also form a node on the network. The connection between the users 402, 420 and the server 416 may be any number of standard networking interfaces. One of ordinary skill in the art will appreciate that the physical medium connecting the users 402, 420 to the network 414 is not limited to any particular medium and may be comprised of, but not limited to, a wireless connection, an Ethernet connection, etc. Furthermore, the server 416 may include a database 418 or some type of storage device to store interactive content.

The server 416 provides a centralized database for storing interactive content, which may be downloaded by video playback devices 402, 420 over the network 414. In some embodiments, one video playback device 402 may process and generate new interactive content for a particular video 405. The interactive content is then uploaded to the server 416 for future access. Another party may later wish to view a copy 422 of the same video on another video playback device 420 and download interactive content that was created for that video. One should note that the video 422 in video playback device 420 and the video 405 that was processed on the other video playback device 402 may be two separate copies of the same video. On the other hand, a user might process and generate new interactive content for a video at one video playback device 402 and later elect to view the same video on another video playback device 420 but now with the newly created interactive features integrated into the video. Once downloaded, the interactive content provides the user at the remote location with interactive features (e.g., remote control functionality using a mouse). To obtain remote control functionality with a standard input/output device such as a mouse, the second user 420 downloads interactive content associated with the video 422 from the server 416. Upon downloading the interactive content from the server's 416 database 418, the party viewing the video on the video playback device 420 is able to select buttons through the interactive content implemented by the first user 402.

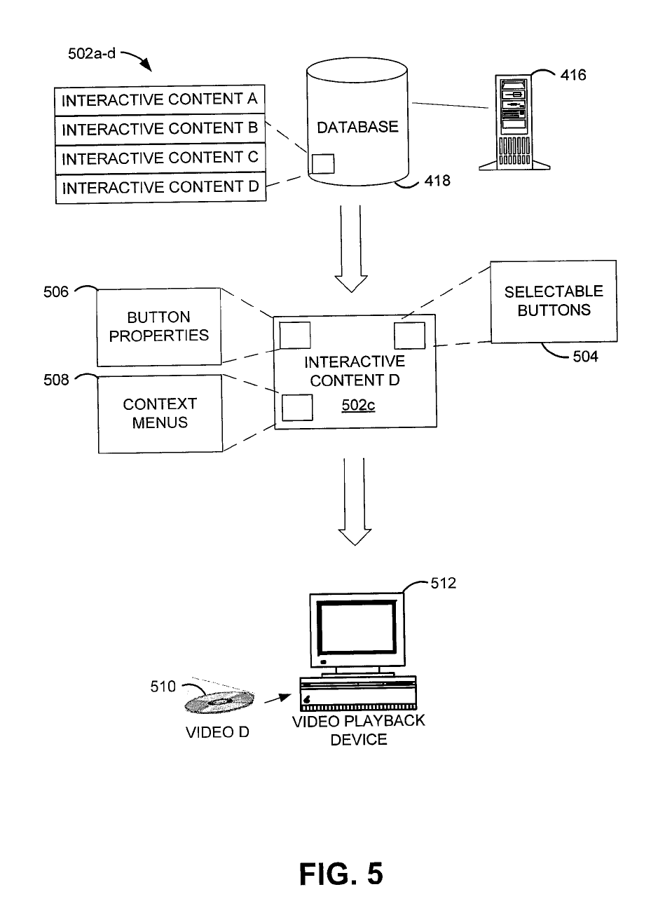

FIG. 5 is a block diagram further illustrating an embodiment of a system for downloading interactive content, which provide remote control functionality in a video playback system. The database 418 on the server 416 may contain interactive content 502a-d for multiple videos. As shown in FIG. 5, “video D” 510 is inserted into video playback device 512. To interact with the video, “interactive content D” 502c, which is associated with “video D” 510, is downloaded from the server 416. Likewise, if “video A” is inserted into the video playback device 512, “interactive content A” 502a, which is associated with “video A,” may be downloaded. In some embodiments, the interactive content may include the following information: properties 506 of all the buttons (e.g., size, transparency level), a catalog 504 of all selectable buttons within the video, and context menus 508 (e.g., menu bars, navigational arrows).

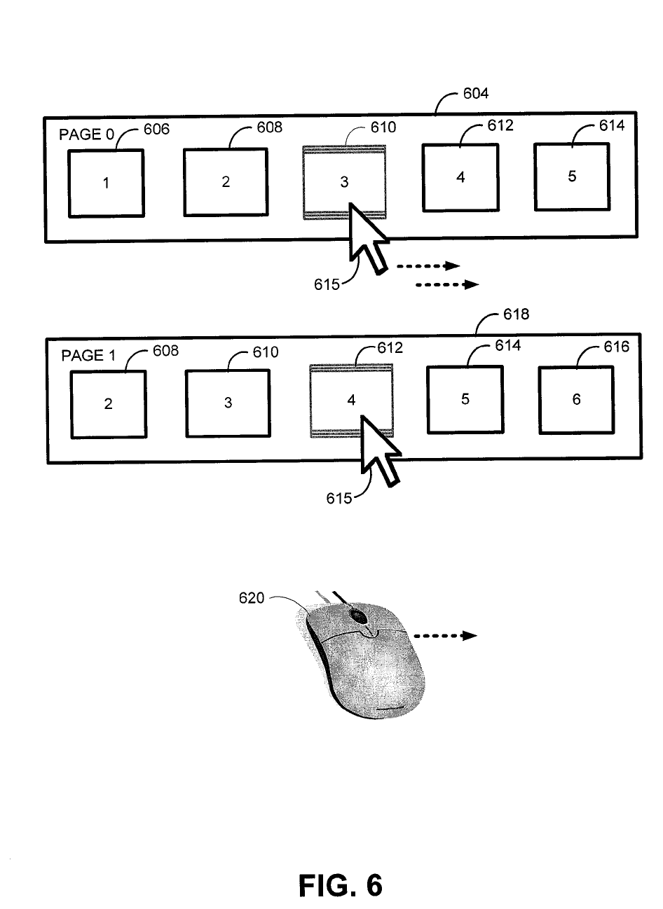

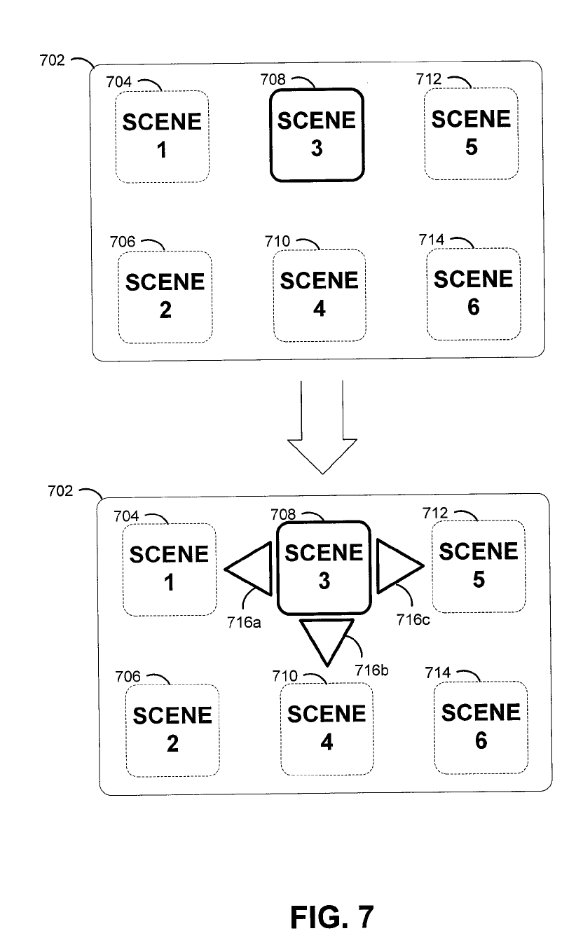

Reference is now made to FIGS. 6 and 7, which illustrate remote control functionality that may be provided by interactive content. FIG. 6 illustrates an example where interactive content provides for selection of buttons within a multi-page menu by dragging a mouse. Consider a situation in which a “Page 0” 604 displays five buttons 606, 608, 610, 612, 614, with the third button 610 currently selected. Furthermore, assume that the third button 610 defines the second button 608 as a left neighbor and the fourth button 612 as a right neighbor. With the third button 610 selected, dragging the mouse in either the left or right directions will result in selection of the corresponding neighbor. Therefore, if the mouse is dragged to the right as illustrated in FIG. 6, the resulting operation may be the presentation of “Page 1” 618, which now shows the fourth button 612 as being selected. From this page, selection of button three 610 or five 614 may be accomplished either to the left or right, in a similar fashion. Similar operations could likewise be implemented by dragging operations in the up or down directions as well.

In FIG. 7, the selection of buttons is accomplished through the use of graphical arrows. A sample page 702 from a menu is shown with various scenes 704, 706, 708, 710, 712, 714 available for selection. Upon downloading interactive content from the server 416, the user is able to navigate within the page 702 through the use of graphical arrows 716a, 716b, 716c. In this example, “SCENE 3” 708 is currently selected. If the user desires to view “SCENE 4” 710 instead, he simply clicks on the down arrow 716b to select that particular scene. Likewise, if the user wants to view “SCENE 5” 712, he simply clicks on the right arrow 716c to select that particular scene.

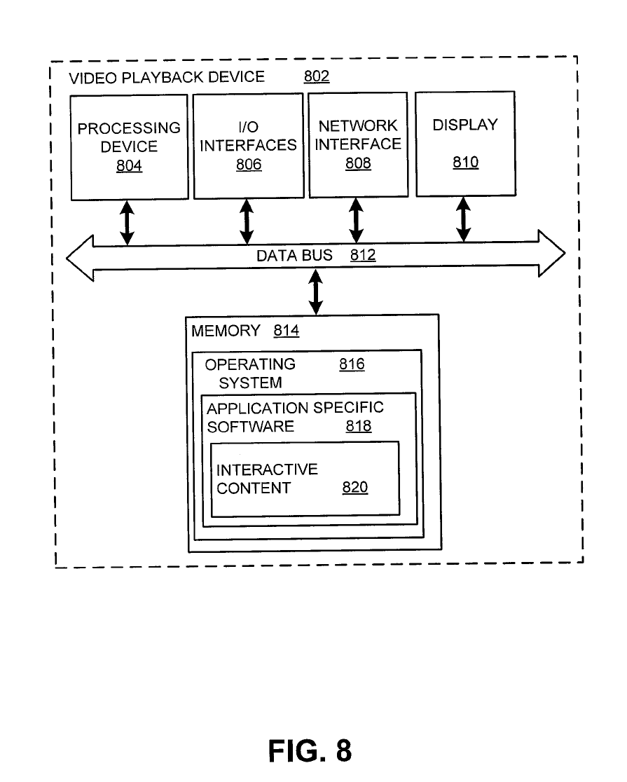

FIG. 8 is a block diagram illustrating an exemplary embodiment of a system for downloading interactive content. Generally speaking, a video playback device 802 can comprise any one of a wide variety of wired and/or wireless computing devices, such as a desktop computer, portable computer, dedicated server computer, multiprocessor computing device, cellular telephone, personal digital assistant (PDA), handheld or pen based computer, embedded appliance and so forth. Irrespective of its specific arrangement, the video playback device 802 can, for instance, comprise memory 814, a processing device 804, a number of input/output interfaces 806, a network interface device 808, wherein each of these devices are connected across a data bus 812. Display 810 can comprise a computer monitor or a plasma screen for a PC or a liquid crystal display (LCD) on a hand held device, for example.

Processing device 804 can include a custom-made or commercially available processor, a central processing unit (CPU) or an auxiliary processor among several processors associated with the video playback device 802, a semiconductor based microprocessor (in the form of a microchip), a macroprocessor, one or more application specific integrated circuits (ASICs), a plurality of suitably configured digital logic gates, and other well known electrical configurations comprising discrete elements both individually and in various combinations to coordinate the overall operation of the computing system.

The memory 814 can include any one of a combination of volatile memory elements (e.g., random-access memory (RAM, such as DRAM, and SRAM, etc.)) and nonvolatile memory elements (e.g., ROM, hard drive, tape, CDROM, etc.). The memory 814 typically comprises a native operating system 816, one or more native applications, emulation systems, or emulated applications for any of a variety of operating systems and/or emulated hardware platforms, emulated operating systems, etc. For example, the applications may include an application specific program 818 for downloading and utilizing interactive content 820. One of ordinary skill in the art will appreciate that memory 814 can, and typically will, comprise other components, which have been omitted for purposes of brevity.

When the application specific program 818 is implemented in software, it should be noted that the system can be stored on a variety of computer-readable medium for use by, or in connection with, a variety of computer-related systems or methods. In the context of this document, a computer-readable medium may comprise electronic, magnetic, optical, or other physical device or apparatus that can contain or store a computer program for use by or in connection with a computer-related system or method. The interface can be embedded in a variety of computer-readable medium for use by, or in connection with, an instruction execution system, apparatus, or device, such as a computer-based system, processor-containing system, or other system that can fetch the instructions from the instruction execution system, apparatus, or device and execute the instructions.

In the context of this document, a “computer-readable medium” stores, communicates, propagates, or transports the program for use by or in connection with the instruction execution system, apparatus, or device. The computer readable medium can be, for example, but not limited to, an electronic, magnetic, optical, electromagnetic, infrared, or semiconductor system, apparatus, device, or propagation medium. More specific examples (a non-exhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM, EEPROM, or Flash memory) (electronic), an optical fiber (optical), and a portable compact disc read-only memory (CDROM) (optical).

Input/output interfaces 806 provide any number of interfaces for the input and output of data. For example, where the video playback device 802 comprises a personal computer, these components may interface with a user input device 806, which may be a keyboard or a mouse. Where the video playback device 802 comprises a handheld device (e.g., PDA, mobile telephone), these components may interface with function keys or buttons, a touch sensitive screen, a stylist, etc.

With further reference to FIG. 8, network interface device 808 comprises various components used to transmit and/or receive data over a network 414. By way of example, the network interface device 808 may include a device that can communicate with both inputs and outputs, for instance, a modulator/demodulator (e.g., a modem), wireless (e.g., radio frequency (RF)) transceiver, a telephonic interface, a bridge, a router, network card, etc.)

It should be emphasized that the above-described embodiments are merely examples of possible implementations. Many variations and modifications may be made to the above-described embodiments without departing from the principles of the present disclosure. All such modifications and variations are intended to be included herein within the scope of this disclosure and protected by the following claims.

At least the following is claimed:

1. A method for selecting buttons in a video comprising:
downloading interactive content associated with the video from a server, wherein the interactive content identifies all selectable buttons in each page within the video and contains the properties of each button; and
interacting with the video using the interactive content.

2. The method of claim 1, wherein the interactive content was generated by a third party who processed a copy of the same video.

3. The method of claim 1, wherein interacting with the video comprises:
selecting buttons using a mouse.

4. The method of claim 3, wherein selecting buttons comprises:
depressing a key on the mouse while the mouse is positioned over a first button currently selected;
dragging the mouse in the direction of a second button to be selected while depressing the key; and
releasing the key on the mouse once the mouse is positioned over the second button to select the second button.

5. The method of claim 3, wherein selecting buttons comprises:
visibly distinguishing a first button in a selected state among the selectable buttons;
dragging the mouse in the direction of a second button to be selected; and
ceasing movement of the mouse when the second button is selected.

6. The method of claim 3, wherein selecting buttons comprises:
positioning the mouse over one of the selectable buttons; and
displaying a context menu upon depressing a key on the mouse, the context menu presenting a user with possible actions that can be performed in relation to the button.

7. The method of claim 3, wherein buttons comprises:
utilizing a graphic display provided by the interactive content to navigate between selectable buttons, wherein the graphic display presents to a user all available actions that can be performed in relation to the button based on the properties of the button.

8. The method of claim 1, wherein downloading interactive content is performed over the Internet.

9. The method of claim 1, wherein the properties of each button include whether the button is selectable.

10. The method of claim 1, wherein the properties of each button include whether the button is transparent.

11. The method of claim 1, wherein the properties of each button include whether the button is smaller than a predetermined size.

12. A system for selecting buttons in a video comprising:
a server for storing interactive content associated with a first video; and
a video playback device containing a second video, wherein the video playback device is configured to download the interactive content, which allows a user to interact with the second video.

13. The system of claim 12, wherein the second video is a copy of the first video.

14. The system of claim 12, wherein the interactive content identifies all selectable buttons and properties of each button.

15. The system of claim 12, wherein interacting with the second video comprises selecting buttons with a standard input/output device.

16. The system of claim 12, wherein the server stores interactive content for a plurality of videos.

17. The system of claim 12, downloading the interactive content is performed over a network.

18. A computer readable medium having a program stored thereon for selecting buttons in a video comprising:
logic configured to download interactive content from a server, wherein the interactive content identifies all selectable buttons in each page within the video and contains the properties of all the buttons; and
logic configured to select a button through the interactive content.

19. The computer readable medium of claim 18, wherein downloading the interactive content is performed over a network.

20. The computer readable medium of claim 18, wherein the program further comprises:
logic configured to upload new interactive content to the server over a network.
